(19) United States
(12) Patent Application Publication
(10) Pub. No.: US 2006/0075114 A1
(43) Pub. Date: Apr. 6, 2006

(54) In-line modification of protocol handshake by protocol aware proxy

(75) Inventors: Anatoliy Panasyuk, Bellevue, WA (US); David Sean Stone, Lauderdale By-The-Sea, FL (US); Bradley Jay Pedersen, Parkland, FL (US)

Correspondence Address: CHOATE, HALL & STEWART LLP, TWO INTERNATIONAL PLACE, BOSTON, MA, 02110, US

(73) Assignee: Citrix Systems, Inc., Fort Lauderdale, FL (US)

(21) Appl. No.: 10/957,165

(22) Filed: Sep. 30, 2004

(51) Int. Cl. G06F 15/16

(52) U.S. Cl. 709/227

(57) ABSTRACT

The present invention relates to systems and methods for network communication between a client and server via multiple proxies. A network protocol is used to establish and control an end-to-end connection between the client and the server via a single handshake mechanism. Through the protocol and end-to-end handshake, the proxies can participate in the establishment of the end-to-end connection. The present invention also provides a method and system by which a connection from one end-point to another end-point can be independently controlled and configured by the proxies along the connection path. Furthermore, the protocol is forward-compatible so that different proxies can be upgraded to different protocol versions at different times and the end-to-end connection control continues to operate.

### TECHNICAL FIELD

The invention generally relates to network communications. More particularly, the invention relates to systems and methods for connecting a client to a destination server through multiple proxy servers.

### BACKGROUND INFORMATION

Organizations typically provide a wide range of network resources to a diverse user community over complex network topologies. Organizations also typically partition their network topology into various network segments to support controlling and managing access to these network resources. Many times, proxy servers are used as intermediary servers to provide a mechanism for traversing through the variety of network segments to provide user access in complex network topologies. As such, a proxy is an intermediate link between users and network resources to assist in controlling and managing access. Additionally, a user on a client may traverse multiple network segments through a series of proxy servers to gain access to network resources. Therefore, the user's end-to-end connection to the network resource may comprise multiple network connections through multiple proxy servers over multiple networks or network segments.

In general, a proxy controls and manages the immediate connection between itself and an adjacent proxy or server. Typically, each proxy establishes a connection with an adjacent proxy or server using a different set of network protocols than a previous connection in the user's end-to-end connection to the network resource. The proxy server and adjacent server perform a handshake transaction sequence to establish a connection using a protocol for that connection. Therefore, the user's end-to-end connection to a network resource through multiple proxy servers will consist of a series of unrelated handshakes using different protocols between each proxy and adjacent server in the connection path. As a result, the user's end-to-end connection to the network resource is made up of a range of different networking protocols, different connections and different proxies, with each connection managed by the proxy establishing the connection. Furthermore, in performing server management and maintenance, each of the proxy servers may be upgraded with different protocols or different versions of protocols. Additionally, these proxy servers may be upgraded at different times relative to other proxies and servers. Continual changes to the different proxy servers and protocols used in the end-to-end connection of a client to a network resource can further impact the complexities of the network topology.

As the complexities of network topologies increase, controlling and managing the access of diverse users to the variety of network resources becomes increasingly challenging. Controlling and managing access of users traversing various network segments and network connections is particularly challenging when considering the different protocols that may be used and that a connection is made up of multiple connections across proxies. Since each proxy is focused on its immediate connection and dependent on the protocol, a proxy does not participate in the end-to-end connection establishment and controls. As such, organizations find it difficult to control such characteristics as access, quality of service, and security and policy enforcement on these connections. Thus, it is desirable for organizations to control the characteristics of end-to-end network connections that traverse the network topology through multiple proxies.

### SUMMARY OF THE INVENTION

The present invention relates to systems and methods for establishing and controlling a connection from a client to a destination server via multiple proxies using a network protocol. A forward-compatible network protocol is used to establish connections and control characteristics of the connection by providing a single handshake transaction across the proxies and between the client and the destination server. The network protocol comprises data blocks which specify characteristics for the end-to-end connection. One or more proxies can inspect the data blocks and independently participate in controlling the end-to-end connection. In summary, the present invention provides systems and methods to establish and control an end-to-end connection between a client and destination server by which the proxy servers can independently control the entire connection.

In one aspect, the present invention relates to a method for network communications. The method comprises the step of transmitting, by one of a client and a first proxy via a proxy protocol, a handshake request packet to a second proxy. The handshake request packet comprises one or more data blocks. The method includes the step of initiating, by the second proxy, a change to the handshake request packet. The change comprises one of modifying, adding and deleting a data block of the one or more data blocks. The method further includes the step of forwarding, by the second proxy via the proxy protocol, the changed handshake request packet to one of a third proxy and a destination server; receiving. The second proxy receives via the proxy protocol a handshake response packet representing a result from forwarding the handshake request to the destination server. The second proxy via the proxy protocol replies to the handshake request packet sent, by one of the client and the first proxy, with the handshake response packet.

In one embodiment, at least one of the one or more data blocks comprises a field indicating the total length of the data block. In another embodiment, at least one of the one or more data blocks comprises data describing the type of data block. Additionally, the one or more data blocks may represent a capability of one of the first proxy, the second proxy and the third proxy. In one embodiment, at least one of the one or more data block comprises information describing one or more of the following capabilities: compression, security and encryption. In another embodiment, at least one of the one or more data blocks represents a policy to be applied to the connection between the client and the destination. The policy may comprise rules associated with one or more of the following: compression, security, and encryption.

In another embodiment, the method further comprises the step of recognizing, by the second proxy, the type of at least one of the one or more data blocks. In one embodiment, the method further comprises the step of ignoring, by the second proxy, one of the one or more data blocks. In yet another embodiment, the method further comprises initiating, by the second proxy, a change to the handshake response packet. The handshake request packet may comprise a request from the client to connect to the destination server, and the handshake response packet may comprise a reply from the destination server to a request from the client to connect to the destination server. In a further embodiment, the proxy protocol comprises the Common Gateway Protocol. In another embodiment, the proxy protocol comprises the SOCKS protocol. In yet another embodiment, the proxy protocol is forward-compatible.

In another aspect, the present invention relates to a method for establishing a connection between a client and a destination server via a handshake across multiple proxies. The method comprises the steps of sending, by a client via a proxy protocol to a first proxy, a connection request to connect to a destination server. The connection request comprises at least one data block. The method also includes forwarding, by the first proxy via the proxy protocol, the connection request to a second proxy, and forwarding, by the second proxy via the proxy protocol, the connection request to the destination server. The method further comprises the step of receiving, by the second proxy via the proxy protocol, a reply to the connection request from the destination server. The reply comprises at least one data block. The method also provides the steps of forwarding, by the second proxy via the proxy protocol, the reply to the first proxy, and replying, by the first proxy via the proxy protocol, to the connection request of the client with the reply from the destination server.

In one embodiment, the method further comprises the step of taking, by one of the first proxy and the second proxy, an action to perform one of the following changes to the connection request: adding a data block, modifying the least one data block, and removing the least one data block. In another embodiment, the method of claim further comprises the step of taking, by one of the first proxy and the second proxy, an action to perform one of the following changes to the reply: adding a data block, modifying the least one data block, and removing the least one data block. In a further embodiment, the method also includes the step of establishing a connection between the client and the destination server. In yet another embodiment, the method also further comprises the step of forwarding, by the first proxy and the second proxy, communications from the client to the destination server via the connection.

In another embodiment, the connection request comprises at least one data block representing an operational characteristic of the connection to be connected between the client and the destination server. In one embodiment, the connection request comprises at least one data block representing a policy to be enforced for the connection between the client and the destination server. The policy may comprise one or more rules associated with one of compression, security and encryption. In yet another embodiment, the method further comprises the step of enforcing, by one of the first proxy and the second proxy, the policy represented by the least one data block.

In one embodiment, the least one data block of one of the connection request and the reply represents a capability to be configured within a proxy. In another embodiment, one of the first proxy and the second proxy reads the least one data block and takes an action to apply the capability in handling the connection between the client and the destination server. In a further embodiment, the first proxy comprises a version of the proxy protocol different than the version of the proxy protocol of one of the second proxy and the destination server. Additionally, the second proxy and the destination server ignore at least one of the data blocks in communications from the first proxy comprising the different version of the proxy protocol. In yet another embodiment, at least one of the data blocks of one of the connection request and reply comprises a ticket.

In a further aspect, the present invention relates to a system for establishing a connection between a client and a destination server through a plurality of proxies. The system comprises a client communicating, via a proxy protocol, a connection request to establish a connection with a destination server. The connection request comprises one or more data blocks. The system also comprises a first proxy, in communication with the client via the proxy protocol, receiving the connection request and forwarding the connection request. Furthermore, the system also comprises a second proxy, in communication with the first proxy via the proxy protocol, receiving the connection request forwarded by the first proxy. The second proxy forwards the connection request to the destination server, and the destination server, in communication with the second proxy via the proxy protocol, replies to the connection request by communicating a reply to the second proxy. The reply comprises one or more data blocks. The second proxy receives the reply and forwards the reply to the first proxy, and the first proxy receives the reply and communicates the reply to the client in response to the connection request by the client.

In one embodiment, one of the first proxy and the second proxy perform a change to the one or more data blocks of the connection request, the change comprising one of the following: adding a data block, modifying one of the one or more data blocks, removing one of the one or more data blocks. In another embodiment, one of the first proxy and the second proxy perform a change to the one or more data blocks of the reply, the change comprising one of the following: adding a data block, modifying one of the one or more data blocks, removing one of the one or more data blocks. The system also includes the first proxy and the second proxy establishing a connection between the client and the destination server. In another embodiment, the first proxy and the second proxy forward communications from the client to the destination server via the connection.

In another embodiment, the connection request comprises at least one data block representing an operational characteristic of the connection between the client and the destination server. In one embodiment, the connection request comprises at least one data block representing a policy to be enforced for the connection between the client and the destination server. In yet another embodiment, the policy comprises one or more rules associated with one of compression, security and encryption. In a further embodiment, the first proxy and the second proxy enforces the policy on the connection.

In another embodiment, the least one data block of one of the connection request and the reply represents a capability to be configured by a proxy. One of the first proxy and the second proxy reads one of the one or more data blocks and takes an action to apply the capability in handling the connection between the client and the destination server. In yet another embodiment, the first proxy uses a version of the proxy protocol different than the version of the proxy protocol used by of one of the second proxy and the destination server. Additionally, either the second proxy or the destination server may ignore one of the one or more data blocks in communications from the first proxy comprising the different version of the proxy protocol. In a further embodiment, one of the one or more data blocks of one of the connection request and the reply comprises a ticket.

The details of various embodiments of the invention are set forth in the accompanying drawings and the description below.

### BRIEF DESCRIPTION OF THE DRAWINGS

The foregoing and other objects, aspects, features, and advantages of the invention will become more apparent and may be better understood by referring to the following description taken in conjunction with the accompanying drawings, in which:

FIGS. 1A and 1B are block diagrams of embodiments of a computing device for practicing an illustrative embodiment of the present invention;

FIG. 2 is a block diagram of a network computer system for practicing an illustrative embodiment of the present invention;

FIGS. 3A and 3B are block diagrams of illustrative embodiments of the present invention;

FIG. 4 is a flow diagram of steps performed in practicing the illustrative embodiments of FIGS. 3A-3B;

FIG. 5 is a block diagram of an illustrative system of the present invention; and

FIG. 6 is a flow diagram of steps performed in practicing the illustrative embodiment of FIG. 5.

### DESCRIPTION

Certain illustrative embodiments of the present invention are described below. It is, however, expressly noted that the present invention is not limited to these embodiments, but rather the intention is that additions and modifications to what is expressly described herein also are included within the scope of the invention. Moreover, it is to be understood that the features of the various embodiments described herein are not mutually exclusive and can exist in various combinations and permutations, even if such combinations or permutations are not expressly made herein, without departing from the spirit and scope of the invention.

The illustrative embodiments of the present invention provide for establishing and controlling a connection between a client and destination server via multiple proxies using a network protocol. The present invention provides a protocol and a system by which a connection from one end-point to another end-point can be independently controlled and configured by proxies along the connection path. Furthermore, the protocol is forward-compatible so that different proxies can be upgraded to different protocol versions at different times and the end-to-end connection management continues to work. The system and protocol also provides for a single handshake between the client and destination server so that the proxies can participate in the establishment and control of the end-to-end connection.

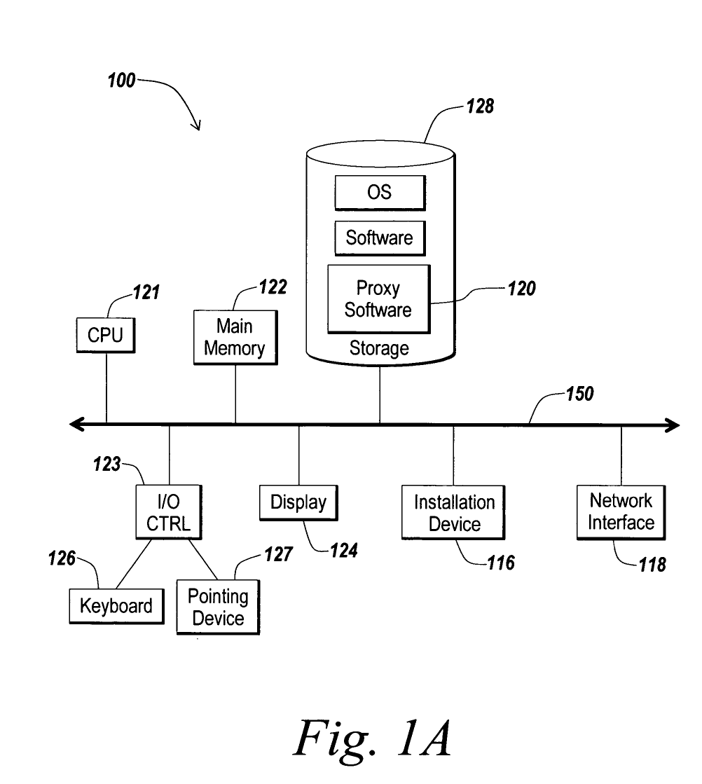

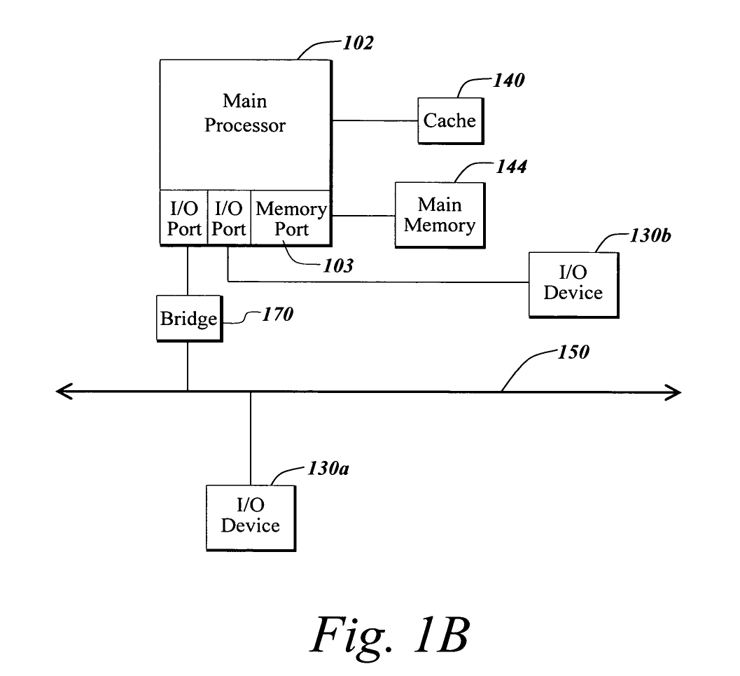

FIGS. 1A and 1B depict block diagrams of a computing device 100 useful for practicing an embodiment of the present invention. As shown in FIGS. 1A and 1B, each computing device 100 includes a central processing unit 102, and a main memory unit 104. As shown in FIG. 1A, a typical computing device 100 may include a visual display device 124, a keyboard 126 and/or a pointing device 127, such as a mouse. Each computing device 100 may also include additional optional elements, such as one or more input/output devices 130a-130b (generally referred to using reference numeral 130), and a cache memory 140 in communication with the central processing unit 102.

The central processing unit 102 is any logic circuitry that responds to and processes instructions fetched from the main memory unit 104. In many embodiments, the central processing unit is provided by a microprocessor unit, such as: the 8088, the 80286, the 80386, the 80486, the Pentium, Pentium Pro, the Pentium II, the Celeron, or the Xeon processor, all of which are manufactured by Intel Corporation of Mountain View, Calif.; the 68000, the 68010, the 68020, the 68030, the 68040, the PowerPC 601, the PowerPC604, the PowerPC604e, the MPC603e, the MPC603ei, the MPC603ev, the MPC603r, the MPC603p, the MPC740, the MPC745, the MPC750, the MPC755, the MPC7400, the MPC7410, the MPC7441, the MPC7445, the MPC7447, the MPC7450, the MPC7451, the MPC7455, or the MPC7457 processor, all of which are manufactured by Motorola Corporation of Schaumburg, Ill.; the Crusoe TM5800, the Crusoe TM5600, the Crusoe TM5500, the Crusoe TM5400, the Efficeon TM8600, the Efficeon TM8300, or the Efficeon TM8620 processor, manufactured by Transmeta Corporation of Santa Clara, Calif.; the RS/6000 processor, the RS64, the RS 64 II, the P2SC, the POWER3, the RS64 III, the POWER3-II, the RS 64 IV, the POWER4, the POWER4+, the POWER5, or the POWER6 processor, all of which are manufactured by International Business Machines of White Plains, N.Y.; or the AMD Opteron, the AMD Athlon 64 FX, the AMD Athlon, or the AMD Duron processor, manufactured by Advanced Micro Devices of Sunnyvale, Calif. The computing device 100 may be based on any of the above described processors, or any other processor capable of operating as described herein.

Main memory unit 104 may be one or more memory chips capable of storing data and allowing any storage location to be directly accessed by the microprocessor 102, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). The main memory 104 may be based on any of the above described memory chips, or any other available memory chips capable of operating as described herein. In the embodiment shown in FIG. 1B, the processor 102 communicates with main memory 104 via a system bus 150 (described in more detail below). FIG. 1B depicts an embodiment of a computing device 100 in which the processor communicates directly with main memory 104 via a memory port 103. For example, in FIG. 1B the main memory 104 may be DRDRAM.

FIGS. 1A and 1B depict embodiments in which the main processor 102 communicates directly with cache memory 140 via a secondary bus, sometimes referred to as a backside bus. In other embodiments, the main processor 102 communicates with cache memory 140 using the system bus 150. Cache memory 140 typically has a faster response time than main memory 104 and is typically provided by SRAM, BSRAM, or EDRAM.

In the embodiment shown in FIG. 1A, the processor 102 communicates with various I/O devices 130 via a local system bus 150. Various busses may be used to connect the central processing unit 102 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 102 may use an Advanced Graphics Port (AGP) to communicate with the display 124. FIG. 1B depicts an embodiment of a computer 100 in which the main processor 102 communicates directly with I/O device 130b via HyperTransport, Rapid I/O, or InfiniBand. FIG. 1B also depicts an embodiment in which local busses and direct communication are mixed: the processor 102 communicates with I/O device 130a using a local interconnect bus while communicating with I/O device 130b directly.

The computing device 100 may support any suitable installation device 116, such as a floppy disk drive for receiving floppy disks such as 3.5-inch, 5.25-inch disks or ZIP disks, a CD-ROM drive, a CD-R/RW drive, a DVD-ROM drive, tape drives of various formats, USB device, hard-drive or any other device suitable for installing software and programs such as the proxy software 120 related to the present invention.

The computing device 100 may further comprise a storage device 128, such as one or more hard disk drives or redundant arrays of independent disks, for storing an operating system and other related software, and for storing application software programs such as any program related to the proxy software 120 of the present invention. Optionally, any of the installation devices 118 could also be used as the storage device 128. Additionally, the operating system and the proxy software 120 can be run from a bootable medium, for example, a bootable CD, such as KNOPPIX®, a bootable CD for GNU/Linux that is available as a GNU/Linux distribution from knoppix.net.

Furthermore, the computing device 100 may include a network interface 118 to interface to a Local Area Network (LAN), Wide Area Network (WAN) or the Internet through a variety of connections including, but not limited to, standard telephone lines, LAN or WAN links (e.g., 802.11, T1, T3, 56 kb, X.25), broadband connections (e.g., ISDN, Frame Relay, ATM), wireless connections, or some combination of any or all of the above. The network interface 118 may comprise a built-in network adapter, network interface card, PCMCIA network card, card bus network adapter, wireless network adapter, USB network adapter, modem or any other device suitable for interfacing the computing device 100 to any type of network capable of communication and performing the operations described herein.

A wide variety of I/O devices 130a-130n may be present in the computing device 100. Input devices include keyboards, mice, trackpads, trackballs, microphones, and drawing tablets. Output devices include video displays, speakers, inkjet printers, laser printers, and dye-sublimation printers. The I/O devices may be controlled by an I/O controller 123 as shown in FIG. 1A. The I/O controller may control one or more I/O devices such as a keyboard 126 and a pointing device 127, e.g., a mouse or optical pen. Furthermore, an I/O device may also provide storage 128 and/or an installation medium 118 for the computing device 100. In still other embodiments, the computing device 100 may provide USB connections to receive handheld USB storage devices such as the USB Flash Drive line of devices manufactured by Twintech Industry, Inc. of Los Alamitos, Calif.

In further embodiments, an I/O device 130 may be a bridge 170 between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 100 of the sort depicted in FIGS. 1A and 1B typically operate under the control of operating systems, which control scheduling of tasks and access to system resources. The computing device 100 can be running any operating system such as any of the versions of the Microsoft® Windows operating systems, the different releases of the Unix and Linux operating systems, any version of the MacOS® for Macintosh computers, any embedded operating system, any real-time operating system, any open source operating system, any proprietary operating system, any operating systems for mobile computing devices, or any other operating system capable of running on the computing device and performing the operations described herein. Typical operating systems include: WINDOWS 3.x, WINDOWS 95, WINDOWS 98, WINDOWS 2000, WINDOWS NT 3.51, WINDOWS NT 4.0, WINDOWS CE, and WINDOWS XP, all of which are manufactured by Microsoft Corporation of Redmond, Wash.; MacOS, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, Java or Unix, among others.

In other embodiments, the computing device 100 may have different processors, operating systems, and input devices consistent with the device. For example, in one embodiment the computer 100 is a Zire 71 personal digital assistant manufactured by Palm, Inc. In this embodiment, the Zire 71 operated under the control of the PalmOS operating system and includes a stylus input device as well as a five-way navigator device. Moreover, the computing device 100 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

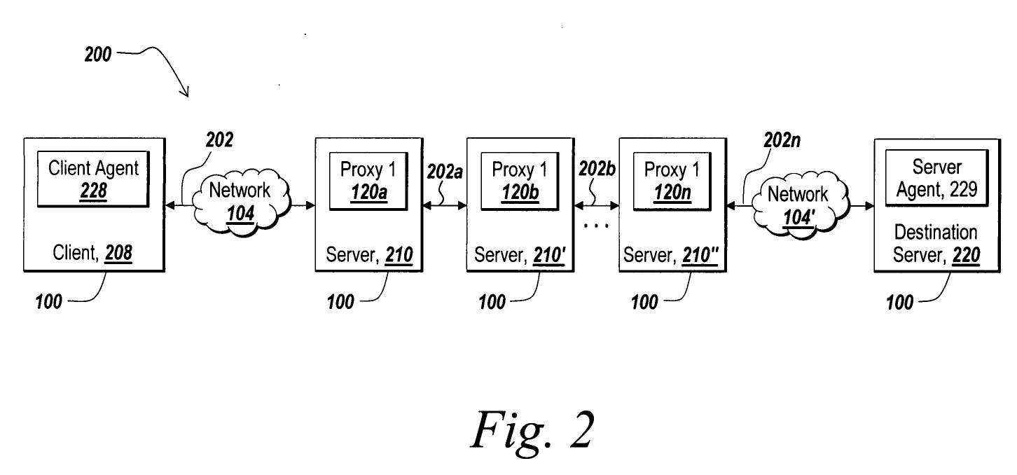

Referring to FIG. 2, in general, the present invention relates to a network system and network communications. In brief overview, one embodiment of a system 200 in which the present invention may be used is depicted. A client 208 communicates with a destination server 220 through one or more proxies 120a-120n over one or more communication networks 104, 104′. Additionally, the system 200 may have one or more clients, e.g. 208, 208′, each communicating to one or more destination servers, e.g., 220, 220′, through one or more proxies 120a-120n over one or more communication networks 104, 104′. The client 208 may communicate with a first proxy 120a over a network connection 202 and the first proxy may communicate with a second proxy 120b over a network connection 202a. In turn, the second proxy 120b communicates with another proxy, proxy N 120n, over network connection 202b, which in turn can communicate via one or more additional proxies 120n over a second network 104′ until communicating with the destination server 220 over network connection 202n. In this manner, the client 208 connects to the destination server 220 via multiple connections 202a-202n through each of the proxies 120a-120n to form a proxied connection 202-202n.

Although FIG. 2 shows a network 104 between the client 208 and the first proxy 120a and a second network 104′ between proxy N 120n and the destination server 220, there may be additional networks, e.g., 104″, 104′″ between each of the proxies 120a-120n. One or more of the client 208, the proxies 120a-120n, and the destination server 220 may be on the same network 104 or network 104′. In one embodiment, some or all of the proxies 120a-120n are on the same network 104 or the network 104′. In another embodiment, the client 208, proxies 120a-120n and destination server 220 are all on network 104. The networks 104 and 104′ can be the same type of network or different types of networks. The network 104 and/or the network 104′ can be a local-area network (LAN), such as a company Intranet, a metropolitan area network (MAN), or a wide area network (WAN), such as the Internet or the World Wide Web. The topology of the network 104 and 104′ may be a bus, star, or ring network topology. The network 104 and network topology may be of any such network or network topology capable of supporting the operations of the present invention described herein.

The client 108, proxy servers 210-210″, and destination server 220 can connect to the one or more networks 104, 104′ through a variety of connections including standard telephone lines, LAN or WAN links (e.g., T1, T3, 56 kb, X.25, SNA, DECNET), broadband connections (ISDN, Frame Relay, ATM, Gigabit Ethernet, Ethernet-over-SONET), and wireless connections or any combination thereof. Connections can be established using a variety of communication protocols (e.g., TCP/IP, IPX, SPX, NetBIOS, Ethernet, ARCNET, Fiber Distributed Data Interface (FDDI), RS232, IEEE 802.11, IEEE 802.11a, IEEE 802.11b, IEEE 802.11g, and direct asynchronous connections).

The client 208 may be any workstation, desktop computer, laptop, handheld computer, mobile telephone, or other computing device 100 capable of communication and that has sufficient processor power and memory capacity to perform the operations described herein. Additionally, the client 108 can be a local desktop client on a local network 104 or can be a remote display client of a separate network 104′. In a similar manner, the proxy servers 210-210″ and the destination server 220 may be any type of computing device 100 capable of operating as described herein. Furthermore, one or more of the proxy servers 210-210″ and/or destination server 220 may be provided as a group of server systems logically acting as a single server system, referred to herein as a server farm. In one embodiment, the destination server 220 is a multi-user server system supporting multiple concurrently active client connections or user sessions.

In some embodiments, as shown in FIG. 2, a client agent 228 is included within the client 208. The client agent 228 can be, for example, implemented as a software program and/or as a hardware device, such as, for example, an ASIC or an FPGA. An example of a client agent 228 with a user interface is a Web Browser (e.g. a Microsoft® Internet Explorer browser and/or Netscape™ browser). The client agent 228 can use any type of protocol and it can be, for example, an HTTP client agent, an FTP client agent, an Oscar client agent, a Telnet client agent, an Independent Computing Architecture (ICA) client agent from Citrix Systems, Inc. of Fort Lauderdale, Fla., or a Remote Desktop Protocol (RDP) client agent from Microsoft Corporation of Redmond, Wash. In an exemplary embodiment, the client agent 228 is configured to connect to one or more of the proxies 120a-120n, such as the first proxy 120a. In some embodiments (not shown), the client 208 includes a plurality of client agents 228, each of which may communicate with a proxy 120a-120n, or a destination server 220, respectively.

The proxies 120a-120n running on the servers 210-210″ provide computer network services which allows the client 208 to make indirect network connections to other network services, such as services provided by the destination server 220. The client 208 connects to the proxy 120a, then requests a connection, file, or other resource available on a different server, such as the server 210′ of proxy 120b, or the desination server 220. The proxy 120a-120n provides the resource, possibly by connecting to the specified server, or by serving it from a cache. In one aspect, the proxy 120a-120n is an intermediary, such as an intermediate server, that sits between the client 208 and the destination server 220. As such, the proxy 120a-120b accepts requests from clients 208, transmits those requests on to the destination server 220, and then returns the response from the destination server 220 to the client 108. If several clients, e.g., 208, 208′ request the same content, the proxy 120a-120n can deliver that content from its cache, rather than requesting it from the destination server 220 each time, thereby reducing response time. In some cases, the proxy 120a-120n may alter the request from the client 208 or the response from the server 220 or the response from other proxies 120a-120n. The proxies 120a-120n may either be configured statically or dynamically to know which adjacent destinations, or other proxies 120a-120n, to forward network communications. In other embodiment, the proxies 120a-120n determine where to forward the network communication from data contained within the network communications, e.g., the header and/or payload of a network packet.

Additionally, one or more of the proxies 120a-120n may be capable of and configured to provide a security gateway or firewall mechanism. A proxy 120a-120n may replace the internet protocol (IP) address of a server 220 on the internally protected network 104′ with its own IP address for all traffic passing through it. The proxy 120a-120n may accept a connection from a client 208 and make a decision as to whether or not the IP address of the client 208 is permitted to use the proxy 120a-120b. The proxy 120a-120b may perform additional authentication, such as validating a ticket provided by the client 208, and then complete a connection 202 on behalf of the client 208 to a remote destination server 220. Furthermore, one or more of the proxies 120a-120n may be capable of and configured to perform functionality such as filtering, security, compression, encryption, etc. In another embodiment, the proxy 120a-120n may perform network address translation. One ordinarily skilled in the art will appreciate the various types of functionality that a proxy may perform.

The proxy 120a-120n may comprise an application, computer program, module, library, web service, or any other software component or program capable of performing the operations described herein. Additionally, the proxy 120a-120n may comprise one or more of an ASIC, FPGA, processor or other integrated circuit capable of performing the operations described herein, and in a further embodiment, may comprise any combination of software and/or hardware components. Also, the proxy 120a-120n may be as part of or otherwise implemented in any type of network device, such as a router, firewall or switch. The proxy 120a-120n may be referred to as a service, a process or a task and may comprise a service, process, task or thread running on the server 210-210′. In one embodiment, the proxy 120a-120n may comprise a portion of the operating system of the computing device 100 or may be a service running with other services of the operating system. Furthermore, the proxy 120a-120n may be integrated with or be part of another application, computer program or system. For example, the proxy 120a-120n may be a component of an application providing internet based security to a web server or corporate internal network 104′. Additionally, one or more proxies 120a-120n may run in conjunction on the same server 210. Although FIG. 2 shows each proxy 120a-120n running on separate servers 210-210″, one or more of the proxies 120a-120n may run on the same server 210, which may be part of a server farm. In another embodiment, components of the proxy 120a-120n may be distributed among servers 210 and 210′. For example, the first proxy 120a may comprise a component running on server 210 and another component running on server 210′. One ordinarily skilled in the art will recongize the plenary of ways a proxy can be constructed and deployed to perform the operations described herein.

Additionally, the destination server 220 may comprise a server agent 229 which may be capable of and configured to work in conjunction with the client agent 128. For example, the server agent 229 may be a server side component that accepts connections and requests from the client agent 228. In another embodiment, the server agent 229 may be capable of and configured to accept proxy connections 202 from one or more of the proxies 120a-120n. In one embodiment, the client agent 228 and server agent 229 may communicate using a protocol, such as http, ICA or RDP, over the connection 220 via the proxies 120a-120n. In another embodiment, the client agent 228 and the server agent 229 establish the start and end points of communications for a proxied connection 220-220n between the client 208 and the destination server 220.

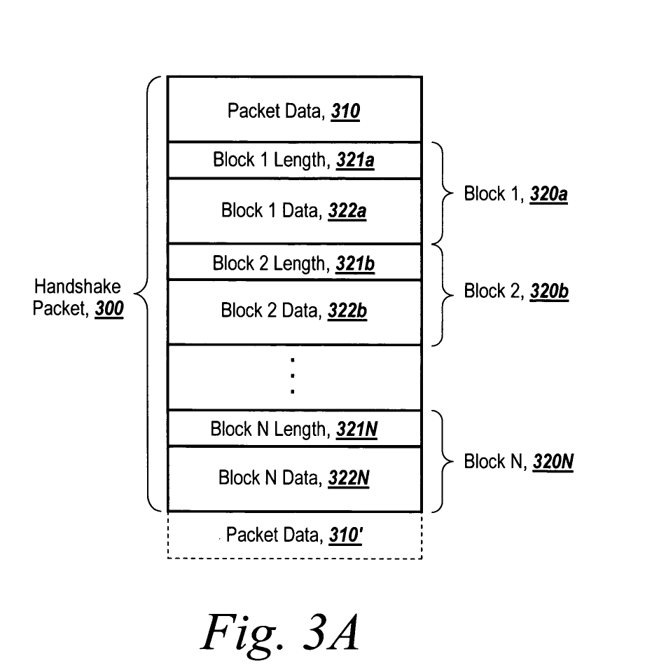

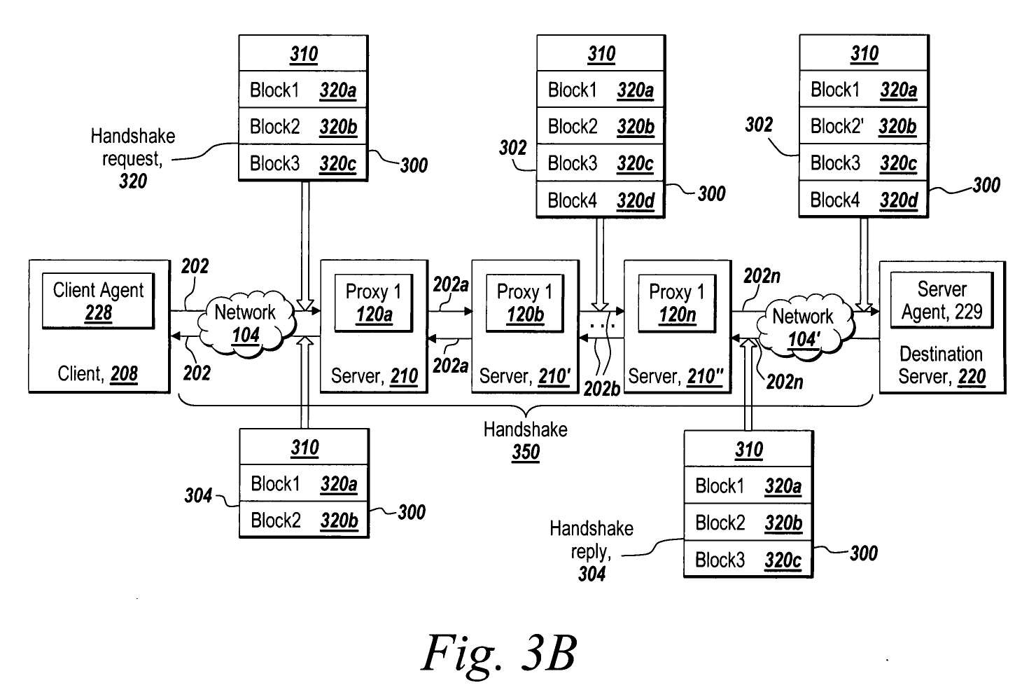

In one aspect, the present invention relates to a network protocol for communications between a client 208 and destination server 220 via multiple proxies 120a-120n. FIG. 3A depicts a handshake packet 300 used to establish and control a proxied connection 202 between the client 208 and the destination server 220. The handshake packet 300 comprises packet data 310 and one or more data blocks 320a-320b. The packet data 310 may comprise any protocol header, or header protocol control information, in a format and structure as implemented by the protocol under which the packet data is transmitted. For example, the packet data 310 may comprise a protocol header identifying the source and/or destination address of the packet, the version of the protocol, a timestamp, command code, operation code, flags, application identifier, checksum, etc. The handshake packet 300 may also comprise packet data 310′ at the end of the packet 300. For example, the handshake packet 300 may have a protocol trailer section of the packet 300. In another embodiment, the packet data 310 may be interweaved between data blocks 320a-320n, and be at either, or both, the header 310 and trailer sections 310′ of the handshake packet 300. The trailing packet data 310′ may be included in the handshake packet 300 in addition to to the header packet data 310. The trailing packet data 310′ may include trailer control information and/or additional header fields not specified in the header section 310 of the handshake packet 300. For example, the trailing packet data 310′ may provide dynamically produced entity header information. In one embodiment, the trailing packet data 310′ comprises a cyclic redundancy check (CRC) to detect any errors which may occur during transmission. One ordinarily skilled in the art will recognize the type of information that may comprise header and trailer packet data 310, 310′ for a protocol.

One or more data blocks 320a-320n comprise the body of the handshake packet 300 and are used to provide configuration, functionality and control of proxied connections 220-220n of the present invention. Each of the one or more data blocks 320a-320n comprises a block length field 321a-321n and block data 322a-322n. A block length field 321a identifies the length of the subsequent data 320a of the data block 320a. The length of the data block 320a may describe the length of the data 322a of the data block 320a with or without the block length field 321a. From another perspective, the block length field 321a-321n may also refer to the size of the data 322a-322n. The block length field 321a-321n may comprise a value indicating the length of the data block 320a-320n in various formats. For example, in one embodiment, the block length field 321a-321n may be an integer value indicating the total number of characters, or bytes, of the data 322a-322n of a data block 320a-320n. In another embodiment, the block length field 321a-321n may be the value of the number of octets, which in some computing devices 100 may be the equivalent to the number of bytes. One may use other units of measure appropriate to the type of data stored in the block data 322a-332n. Each of the one or more data blocks 320a-320n may have different lengths. In another embodiment, each of the data blocks 320a-320n may be the same length, or some may be the same length while others are of different lengths.

The data 322a-322b portion of the one or more data blocks 320a-320b may comprise data representing the configuration and functionality of any proxy 120a-120n forming the network connection 202-202n between the client 208 and the destination server 220. For example, the data 322a of data block 1 320a may comprise data describing the details on the encrytion required for the connection 292, while data block 2 322b comprises data descibing the details of the compression for the connection 202. The data 322a describing the enncryption details may indicate the strength or quality of the encryption. For example, the data 322a may describe the type of algorithm to be used for encryption, e.g, Caesar cipher, and/or the key combination. The data-322b describing the compression details may indicate the type of compression algorithm to be used for compressing data or files transmitted via the connection 202-202n. For example, the type of compression may be a lossless alogorithm such as a flate/deflate compression based on an LZW or Haufmann compression. In another example, the type of compression may be a lossly algorithm such as a JPEG compression. One ordinarily skilled in the art will appreciate the various details about encryption and compression that may be described in one or more of the data blocks 320a-320n.

The data 322a-322n of a data block 320a-320n may also comprise security information. For example, the data 322a-322n may describe the type or method of authentication of the user of the client 208 to the destination server 220. For example, the data 322a-322n may describe that authentication requires a user and password, and optionally, a challenge question/repsonse. In another example, the data 322a-322n describes that mutual authentication of a user/password combination, and optionally, a challenge response is required from the client 208 to the destination server 220, and also from the destination server 220 to the client 208. In a further example, the data 322a of a security data block 320a may comprise data associated with a Challenge Handshake Authentication Protocol (CHAP), such as MD5-CHAP. In yet another example, the data 322a of a security data block 320a may comprise data associated with a Generic Security Services Application Programming Interface (GGSAPI) for performing client-server authentication. In another example, the data 322a-322n may comprise a ticket generated from a ticket service to authenticate the client 208. One ordinarily skilled in the art will recongize the various types of security information that may be described in the data 322a-322n of a data block 320a-320n.

Furthermore, the data blocks 320a-320n of a handshake packet 300 may comprise one or more policies for any functionality to be implemented across the proxied connection 202 202n between the client 208 and the destination server 220. A policy may further comprise one or more rules to be applied by any one of the proxies 320a-320n, client 208, and/or destination server with regards to the connection 202-202n. For example, an encryption data block 320a may describe a policy with a rule that each proxy 120a-120n in the proxied connection 202-202b needs to encrypt handshake packets 300, or data blocks 320a-320n within handshake packets, for every transaction between adjacent proxies 120a-120n. In another example, an encryption rule may indicate that only the proxy 120a-102n transmitting data outside a firewall to a client 208 on an external network 104 needs to perform encryption. In a similar manner, compression and security type data blocks 320a-320n may specify one or more policy rules. For example, a compression policy rule may indicate that the data transmitted from the destination server 220 should be compressed. In another example, maybe only data transmitted from the proxy 120a adjacent to the client 208 should be be compresses. A security data block 320a-320n may comprise a rule that requires periodic re-authentication between the client 208, a proxy 120a-120n and the destination server 220, or that after a pre-determined period of inactivity on the proxied connection 202-202n, re-authenication is required. One ordinarily skilled in the art will appreciate the wide range of rules for compression, encryption, security and other characteristics of the proxied connection 202-202n that may be applied.

In another aspect, the data blocks 320a-320n of a handshake packet 200 comprise configuration data for any of the proxies 120a-120n proxying the connection 202-202n. In this sense, a data block 320a-320n can be considered a capability data block 320a-320n, as the data within the data block represents a capability of a proxy 120a-120n, such as security, to carry out when managing or handling the proxied connection 202-202n. Since each proxy 120a-120n receiving a handshake packet 300 can read and obtain information from the data blocks 320a-320n of the handshake packet 300, a proxy 120a-120n can be configured to apply functionality based on information contained in a data block 320a-320n. For example, a proxy 120a-120n may provide security for the network connection 202-202n by reading in one or more security rules from one or more data blocks 320a-320n, and then applying the rules during proxying the connection 202-202n between the client 208 and the destination server 220. One ordinarily skilled in the art will appreciate how a proxy 120a-120n may be configured to apply a capability in accordance with the present invention.

Although discussed in terms of a single data block 320a comprising the definition of details of a specific functional or configuration area such as compression, encryption or security, a single data block 320a may describe the details for more than one functional area. For example, the first data block 320a in one handshake packet 300 may contain details for both compression and encryption. One ordinarily skilled in the art will appreciate the permutations of the combination of information that may occur within the data 322a-322b of a data blocks 320a-320n.

Furthermore, the handshake packet 300 can be used for both requests and replies in either direction between the client 208 and the destination server 220. This allows either end of the proxied connection 202-202n, i.e., the client 208 and the destination server 220 to control and implement functionality across the connection 202-202n. For example, in one direction a handshake packet 300 sent from the destination server 220 to the client 208 may comprise a ticket in one or more of the data blocks 320a-320n. In the other direction, a handshake packet 300 sent from the client 208 to the destination server 220 may comprise a compression rule to to compress files sent to the client using a certain algorithm. Furthermore, the handshake packet 300 allows any proxy 120a-120n to implement functionality, such as enforcing a policy, on the proxied connection 202-202n in either direction by way of request or reply.

Moreover, although discussed in terms of a data block 320a-320n representing, describing or specifying compression, encryption and security related information, a data block 320a-320n may represent, describe or specify any desired functionality or operational characterisitic of the proxied connection 202-202n between the client 208 and the destination server 220. The data blocks 320a-320n may describe any operational characteristic of the proxied connection 202-202n, such as minimum transmission rate requirements, data bursting and buffering, minimum and maximum number of proxyies 120a-120n, maximum number of clients 208 to share a proxy 120a-120n, timeout periods and re-tries, error handling, and any other factor, consideration, attribute or element that may affect the operation or performance of the network connection 202-202n between the client 208 and the destination server 220. As such, the handshake packet 300 can be used to configure the functionality and operational charactertistics of the entire end-to-end proxied connection 202-202n between the client 208 and the destination server 220.

In another aspect, the data blocks 320a-320n of the handshake packet 300 are self-describing blocks. The blocks 320a-320n comprise a length field 321a-321n to describe the boundaries of the data 322a-322n within the handshake packet 300. Furthermore, the data 322a-322n may comprise other fields or information identifying, specifying or otherwise describing the type of data blocks 320a-320n, e.g., a compression, encryption or security type of data block. In this manner, a proxy 120a-120b can determine if the data blocks 320a-320n is one of interest to the proxy 120a-120n, or if the data block 320a-320n is one that the proxy 120a-120n recognizes and that it can interpret or otherwise process.

By using self-describing data blocks 320a-320n, the handshake packets 300 provides for a forward-compatible protocol mechanism. New types of data blocks 320a-320n can be defined in newer versions of the protocol implementing the handshake packet 300. Proxies 120a-120n in the proxied connection 202-202n that are configured to use an older version of the protocol can skip over these new types of data blocks 320a-320n when processing the handshake packet 300. Therefore, a mixture of proxies 120a-120n implementing different versions of the handshake packet 300 can be used to proxy the connection 202-202n between the client 208 and the destination server 220. This forward-compatibility feature of the handshake packet 300 means that proxies 120a-120n can process the handshake packet 300 implementing different versions of the protocol without the possibility that another proxy 120a-120n in the connection sequence will be of an older implementation and therefore reject the connection, enter an error state, or be unable to continue processing the handshake packet 300 when it encounters the new data blocks 320a-320n.

The self-describing data blocks 320a-320n also enable proxies 120a-120n to manage and control functionality across the entire network connection 202-202n by adding, modifying or deleting data blocks 320a-320n without breaking the connection 202-202b. For example, a first proxy 120a can add a new data block 320n to the handshake packet 300 and a second proxy 120b can still process the handshake packet 300. In this manner, a proxy 120a-120b can feed forward or feed backwards via data blocks 320a-320n to control and manage functionality for which it is responsible. As such, a proxy 120a-120b can control operational aspects of the proxied connection 202-202n beyond its immediate connections 202-202n to adjacent proxies 120a-120n.

In another aspect, the present invention provides for a single handshake between a client 208 and the destination server 220 through the proxied connection 202-202n using a single protocol comprising the handshake packet 300. FIG. 3B depicts the system 200 of FIG. 2 carrying out a single handshake 350 end-to-end from the client 208 to the destination server 220.

In brief overview, the client 208 transmits a handshake request 302 to the destination server 220 via the multiple proxies 120a-120n and obtains a handshake reply 304 from the destination server 220 via the multiple proxies 120a-120n. Instead of a handshake and reply sequence between the client 208 and the first proxy 120a, between each of the proxies 120a-120n, and between the last proxy 120n and the destination server 220, a single handshake 350 is implemented end-to-end across the proxied connection 202-202n. This improves performance and reduces latency between the client 208 and destination server 220 by reducing the number of handshakes to a single handshake 350.

The handshake request 302 initiated by the client 208 comprises a handshake packet 300, which may comprise one or more data blocks 320a-320c. In one embodiment, the handshake request 302 may comprise a handshake packet 300 without any data blocks 320a-320n, and the packet data 310 portion of the handshake packet 300 may comprise the request related information. In a similar fashion, the handshake reply 304 initiated by the destination server 220 in response to the handshake request 302 comprises a handshake packet 300, which may comprise one or more data blocks 320a-320n. In another embodiment, the handshake reply 304 may not include any data blocks 320a-320n with reply related information in the packet data 310 portion of the handshake packet 300. In accordance with the protocol of the handshake packet 300 as discussed above, the proxies 120a-120n may add, modify or delete data blocks 320a-320n of the handshake request 302 and/or handshake reply 304 packets respectively. Additionally, although the handshake 350 is discussed in terms of a handshake request 302 and handshake reply 304 comprising a single handshake packet 300, the handshake request 302 and/or the handshake reply 304 may comprise multiple handshake packets 300, 300′.

Furthermore, the handshake request 302 may comprise a request by the client 208 to connect to the destination server 220. Correspondingly, the handshake reply 304 may comprise a result of submitting the handshake request 302 to the destination server. For example, the handshake reply 304 may indicate whether the connection request was either granted or rejected. In the case of a connection request being rejected, the handshake reply 304 may further include error codes to indicate the type of error. In a further embodiment, the handshake request 302 may comprise a bind request in preparation for an inbound connection from the destination server 220 to the client 208. This bind request may come after the completion of a handshake 350 of a handshake request 302 comprising a connection request. In a similar fashion as the reply to the connection request, the handshake reply 304 may comprise a status generated by the destination server 220 indicating the success or error of the bind request.

In another embodiment, the handshake request 302 may comprise a negotiation request or sub-negotiation request from the client 208 to the destination server 220. For example, the handshake 350 may comprise the negotiation of an authentication method between the client 208 and the destination server 220. Once the authentication method has been determined via a first handshake 350, a second handshake 350′ may be transacted to determine and agree upon details of the authentication method. In the example of a challenge-response type of negotiated authentication method, a sub-negotiation handshake 350′ may comprise the client 208 providing user identification and a response to a challenge in the handshake request 302 to authenticate to the destination server 220. In a further example, for mutual authentication, the client 208 may also include a challenge to the destination server 220 in the handshake request 302. In this case, the destination server 220 may include in the handshake reply 304 a status of the client authentication and a response to the client's challenge.

In a further embodiment, the handshake 350 may comprise an identification request 302 and reply 304 set, for example, to identify version numbers of protocols. In another embodiment, the handshake 350 may comprise a feature discovery request 302 and reply 304 to discover the features available from the destination server 220. Although generally discussed in terms of a request to and reply from the destination server 220, the handshake 350 may occur from the destination server 220 to the client 208. Furthermore, a handshake 350 may occur between the client 208 and any one of the proxies 120a-120n, or between the destination server 220 and any one of the proxies 120a-120n. In some cases, a handshake request 302 sent from the client to the destination server 220 may be replied to by a proxy 120n before reaching the destination server 220. A proxy 120a-120n may have a cached reply, or in another instance, there may be an error reaching the destination server 220. One ordinarily skilled in the art will appreciate the wide range of commands, requests or messages and corresponding replies, if any, that may comprise a handshake 350 and accordingly, the handshake request 302 and handshake reply 304.

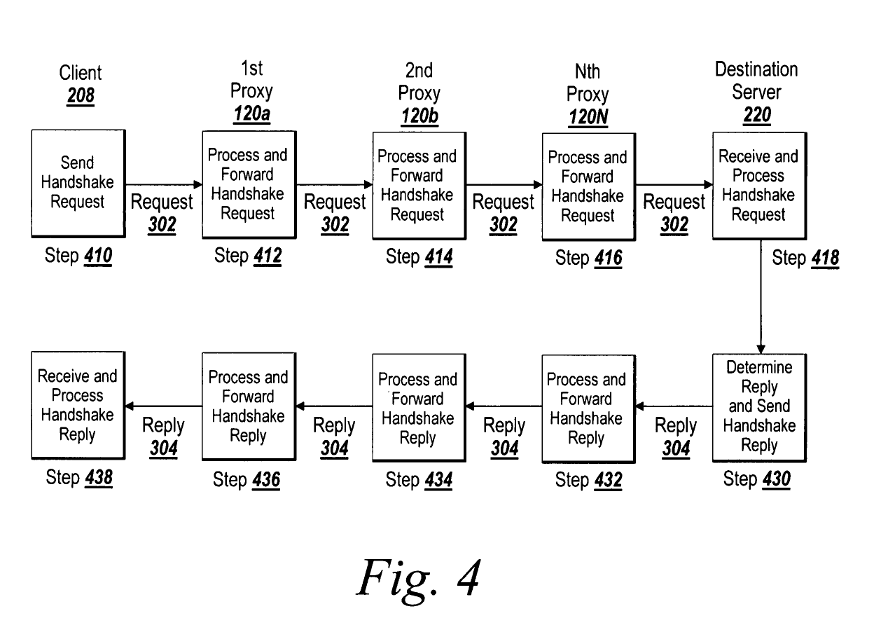

Referring now to FIG. 4, a flow diagram of an illustrative method of practicing the present invention as embodied in FIG. 3B is depicted. In operation, the client 208 at step 410 sends a handshake request 302 for the destination server 220 by way of the first proxy 120a. As illustrated in FIG. 3B, the handshake request 302 may comprise three data blocks of 320a, 320b and 320c. At step 412, the first proxy 120a processes the handshake request 302 and forwards the handshake request 302 to the second proxy 120b. The first proxy 120a may read the data blocks 320a, 320n and 320c, and configured itself based on the data, or read the data to apply the functionality for an established connection. In another embodiment, the first proxy 120a may have skipped over the data blocks 320a-320c as they represent new capabilities of a newer version of the protocol. At step 414 of the illustrative method, the second proxy 120b receives and processes the handshake request 304. In processing the handshake request 302, the second proxy 120b may determine that additional capabilities need to be forwarded to other proxies 120a-120n and/or the destination server 220 as part of the request. As such, the second proxy 120b adds a fourth block 320d to the handshake request 302 and forwards the handshake request 302 as part of step 414 to proxy N 120n.

At step 416, proxy N 120n receives the forwarded handshake request 302 from the second proxy 120b. The handshake request 302 processed by proxy N 120n now has 4 data blocks 320a-320d. As part of its functionality, proxy N 120n may determine that the second data block 320b should be modified before sending to the destination server 220. For example, proxy N 120n may determine that the data 322d of the data block 320d may need to be changed to maintain a desired operational characteristic of the connection 202n, e.g., quality of encryption. Proxy N 120n, at step 416, forwards the handshake request 302 to the destination server 220. At step 418, the destination server 220 receives the handshake request 302 initiated by the client 208 as if the client 208 transmitted the handshake request 302 directly to the destination server 220. As such, the destination server 220 may not know that the handshake request came from proxy N 120n, or otherwise traversed multiple proxies 120a-120n en route to the destination server 220. In this case, the handshake request 302 was forwarded multiple times via the connection 202-202n until it reached the destination server 220 as the request portion of the single handshake 350. The destination server 220 reads and interprets the packet information 310 and/or any of the data blocks 320a-320d of the handshake request 302 to take an action in accordance with the request. For example, the handshake request 302 may comprise a connection request and the destination server 220 takes an action to establish a connection between the client 208 and the destination server 220 via the multiple proxies 120a-120n.

At step 430, the destination server 220, after taking the appropriate action based on the handshake request 302, determines a reply and generates or provides a handshake reply 304. For example, as depicted in FIG. 3B, the handshake reply 304 may comprise the three data blocks of 320a, 320b and 320c. The destination server 220 then transmits the handshake reply 304 back to the client 208 by way of proxy N 120n. At step 432 of the illustrative method of FIG. 4, proxy N 120n will process and forward the handshake reply 304. In processing the handshake reply 304, proxy N 120n may take whatever action based on the contents of the handshake reply 304 and/or the data blocks 320a-032c of the reply 304. At step 434, the second proxy 120b in a similar fashion processes and forwards the handshake reply 304 to the first proxy. By way of example of FIG. 3B, proxy N 120n and the second proxy 120b may not modify the data blocks 320a-320c of the handshake reply 304 when the handshake reply 304 passes through their respective connections. At step 436, the first proxy 120a also processes and forwards the handshake reply 304. The first proxy 120a may remove a data block 320c from the handshake reply 304 as it may have contained a security connection ticket for the first proxy 120a or the client 208. Then, the first proxy 120a communicates the handshake reply 304 to the client 208 in response to the client's initiated handshake request 302. At step 438, the client receives the handshake reply 304 and may do so without knowledge that the handshake reply traversed multiple proxies 120a-120n from the destination server 220. The client 208 may take an action based on the contents of the packet data 310 and/or data blocks 320a-320b of the handshake reply 304. For example, if the client 208 initiated a connection request as part of the handshake request 302, the handshake reply 304 may comprise an error status from the destination server 220 describing a failed connection attempt. As a result, the client 208 may display to a user on the client 208 an error message obtained from the handshake reply 304.

Although the illustrative method of FIG. 4 is discussed by way of example of FIG. 3B, the client 208 could generate a handshake request 302 with no data blocks or any number of data blocks 320a-320n. In a similar fashion, the destination server could generate a handshake reply 304 with no data blocks or any number of data blocks 320a-320n. Furthermore, the handshake request 302 and handshake reply 304 could have had any number of blocks added, removed or modified and still form a single handshake 350 transaction between the client 208 and destination server 220. Moreover, the client 208, the proxies 120a-120n, and the destination server 220 could perform any type of function or capability as desired based on processing of the information contained in the handshake request 302 and handshake reply 304 as it passed through the proxied connection 220-220n.

Although the handshake 350 and the handshake packet 300 is discussed in terms of its own protocol, other protocols such as the proxying protocols of SOCKS, HTML, or the Common Gateway Protocol from Citrix Systems, Inc. of Fort Lauderdale, Fla. may be used to implement the handshake 350 with handshake packets 300 as described herein. Furthermore, since protocols can be defined within protocols, the handshake packet 300 can be implemented within another protocol. For example, the handshake packet 300 may be the data payload of a network packet of another protocol. The advantage of the present invention is that a single network protocol can be used by the client 208, all the proxies 120a-120n and the destination server 220 to establish and control a multiple proxied connection 202-202n. In particular, the client 208 needs to be only setup or otherwise configured for the single proxying protocol to participate in establishing a proxied connection 202-202n to the destination server 220.

In alternative embodiments, the single handshake 350, the handshake request 302 and handshake reply 302 of FIGS. 3 and 4 can also be accomplished by tunneling proxying protocols within each other. This embodiment requires the client 208 to be configured to participate in all of the encapsulating protocols of the proxied connection 202-202n. For example, the client 208 and the destination server 220 may exchange the handshake 350 and handshake packets 300 via an application level protocol, for example, HTML. This application level protocol may be encapsulated in one or more proxying protocols as it traverses the multiple proxies 120a-120c. Each proxying protocol may be responsible for traversing each proxy 120a-120n. As such, each proxy 120a-120n reads the encapsulated packet, processes a level of encapsulation, and forwards the network packet to the next proxy 120a-120n until the final network packet, e.g., without encapsulation, reaches the destination server 220. For example, the client 208 transmits a network packet of an application protocol encapsulated in a first proxying protocol, which is in encapsulated in a second proxying protocol, which in turn is encapsulated in a third proxying protocol. The first proxy 120a processes the network packet at the third proxying protocol level and forwards to the second proxy 120a the network packet encapsulated in the first proxying protocol encapsulated in the second proxying protocol. The second proxy 120b processes the network packet at the second proxying protocol level and forwards to proxy N 120n the network packet encapsulated in the first proxying protocol. Proxy N 120 then processes the network packet and forwards the application level protocol packet to the destination server 220. In a similar fashion, the destination server 220 may send a reply to the client 208 with the reply getting encapsulated by each proxy 120a-120n en route to the client 208.

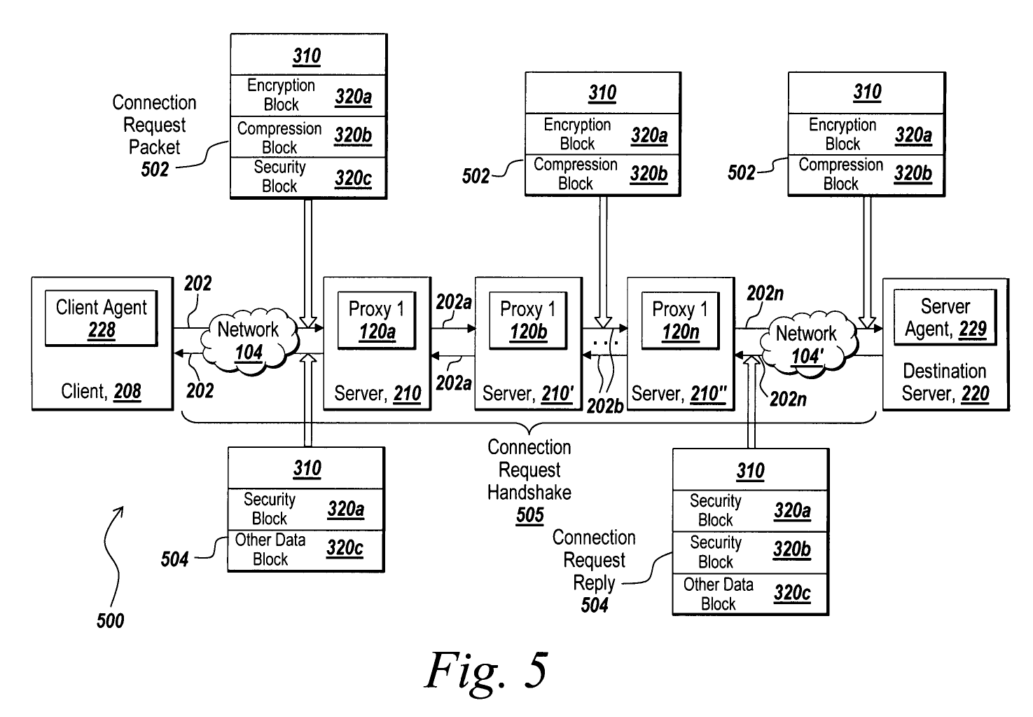

In another aspect, the present invention relates to systems and methods for establishing a proxied connection between a client and a server, and controlling the operational characteristics of the proxied connection from the client to the server. Furthermore, the proxied connection may be established via a single handshake and controlled via a single network protocol as discussed above. FIG. 5 depicts a system 500 for deploying multiple proxies 120a-120n to establish and control a connection 202-202n between the client 208 and the destination server 220. In brief overview, the system 500 comprises a client 208 in communication with a first proxy 120a via network connection 202. The first proxy 120a is in communication with a second proxy 120b via network connection 202a. The second proxy 120b is in communication with proxy N 120n through network connection 202b and proxy N is in communication with the destination server 220 via network connection 202n. Any number of proxies 120a-120n can be part of the proxied network connection 202-202n between the client 208 and the destination server 220.

In accordance with the present invention, each of the proxies 120a-120n can be capable of and configured to perform a specific set of functionality in controlling the operational characteristics of the proxied connection 202-202n. This functionality may be configured and/or exercised via one or more data blocks 320a-320n of a handshake packet 300. Furthermore, the functionality may be established on the first handshake 350 in establishing a proxied connection 202-202n. In another embodiment, the functionality can be controlled dynamically after the proxied connection 202-202n has been established by transmitting handshake packets 300 with the desired functionality. In other embodiments, the proxies 120a-120n may have already been configured and constructed to enforce its own policies or apply it own functionality regardless of the data in the data blocks 320a-320n of a handshake packet 300.

By way of example in reference to FIG. 5, the first proxy 120a may be capable of and configured to act as an outer security gateway. The second proxy 120b may provide encryption policy enforcement, and proxy N 120n may further provide for compression capability. Because of the end-to-end handshake 350 capability and network protocol of the present invention, each of these proxies 120a-120n can perform its functionality for the entire network connection and not just for the immediate network connections adjacent to the proxy 120a-120n.

In the system 500 of FIG. 5, the client 208 establishes a connection 202-202n with the destination server 220 by transmitting a connection request 502 by way of the first proxy 120a. The connection request 502 may comprise connection request related data in either the packet data 310 and/or in the one or more data blocks 320a-320n of the handshake packet 300 of the connection request 502. In the illustrative example of system 500, the connection request 503 comprises an encryption data block 320a, a compression data block 320b and a security data block 320c for configuration and control of the connection 202-202n once established. As part of a single connection request handshake 505, the connection request 502 is forwarded via the multiple proxies 120a-120n to the destination server 220. The destination server 220 processes the connection request 502 and, in response, transmits a connection request reply 504 to the client 208 forwarded by the multiple proxies 120a-120n. By way of example, the connection request reply 504 may comprise three data blocks 320a-320c. Two of the data blocks 320a and 320b may comprise security related functionality such as reconnection tickets for one of the proxies 120a-120n and the client 108. The other data block 320c of the connection request reply 504 may comprise any type of data related to an application being exercised between the client 208 and the destination server 220. For example, the other data block 320c may include a file or document being retrieved from the server, or a client 208 side executable or script. As discussed above in conjunction with FIGS. 3A and 3B, the data blocks 320a-320n of a handshake packet 300 such as the connection request 503 and connection request reply 304 may support any of the desired functionality and operational characteristics of the proxied connection 202-202n.

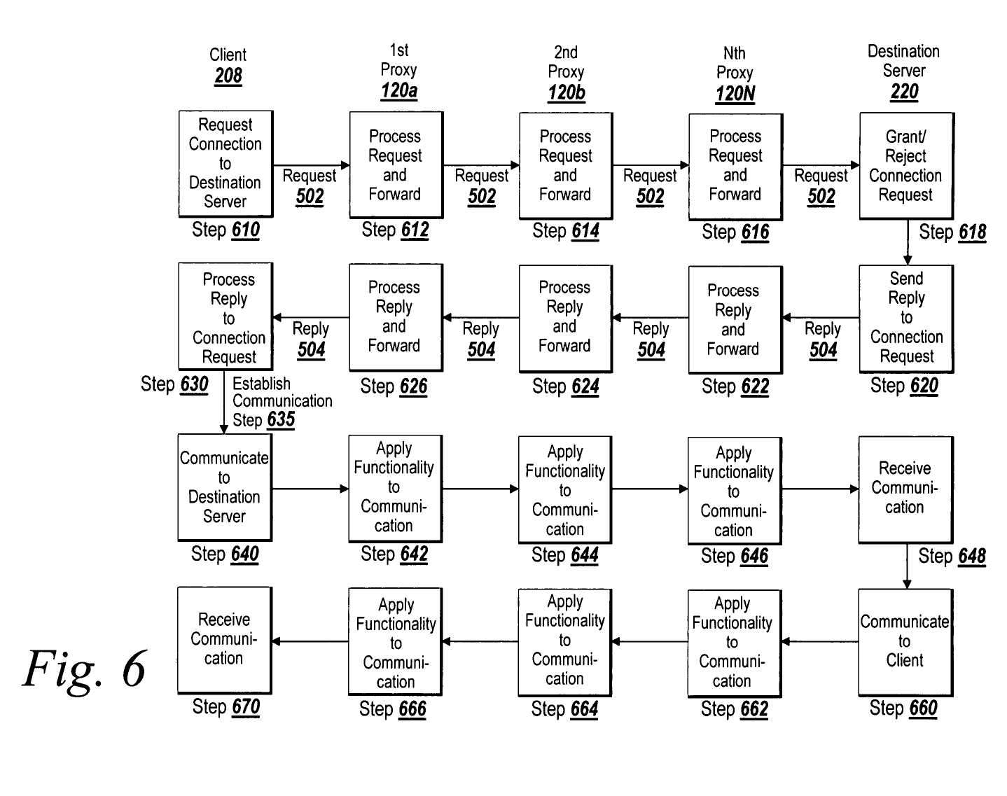

In operation, the client 208 and destination server 210 of system 500 may establish a connection via a single connection handshake 505 as depicted by the illustrative method of FIG. 6. At step 610, the client 208 generates a connection request 502 to request a connection between the client 208 and the destination server 220. The client 208 may further define in the connection request 502 via the data blocks 320a-320c one or more operational characteristics of the connection with regards to compression, encryption and security. For example, the connection request 502 generated by the client 208 may comprise the request for a specific type of compression, such as JPEG compression, a type of encryption, such as Caesar Cipher, and for security, a ticket based authentication, such as a Kerberos type of authentication. At steps 612 through 616, each of the proxies 120a-120n processes the connection request 502 in accordance with their configuration and capabilities and forwards the connection request 502 onto the next proxy 120a-120n. For example, the first proxy 120a at step 612 may read and process the security data block 320c and configure itself and/or take an action to apply the security functionality described in the security data block 320c. The security data block 320a for example may specify a set of security policy rules for the proxied connection 202-202n targeted to be implemented by an outer security gateway such as the first proxy 120a. Or in another example, the security data block 320a may comprise a ticket for the client 208 to be authenticated to a ticket service by one of the proxies 120a-120n or the destination server 220. The first proxy 120a may not be concerned with either the encryption data block 320a and the compression data block 320b, and therefore may skip these data blocks 320a-320b in processing the connection request 502. The first proxy 120a may remove the security data block 320a from the connection request 503 if, for example, the security data block 320a contained information only needed by the first proxy 120a.

The second proxy 320b may be deployed to enforce an encryption policy on the proxied connection 202-202n once established. As such, the second proxy 120b at step 614 may read and process the encryption data block 320a to configure itself or apply the policy rules defined in the data 322a portion of the encryption data block 320a. The second proxy 120b may leave the encryption block 320a in tact before forwarding the connection request 502. This may be done in order to feed the information forward to the destination server 220. In a like manner, proxy N 120n may be configured to support applying and enforcing compression rules on the proxied connection 220-220n. As such, proxy N 120n at step 616 reads and processes the compression information included in the compression data block 320b in order to control encryption on the proxied connection 202-202n. Proxy N 120n may also leave the connection request 502 it received in tact in order to specify to the destination server 220 any compression requirements. For example, the destination server 220 may be required to compress data according to a certain algorithm before transmitting the data through proxy N 120n and then onto to the client 208.

At step 618, the connection request 502 is transmitted to the destination server 220. The destination server 220 determines whether the connection request 502 should be granted based on any combination of information contained in the handshake packet 300 of the connection request 502. For example, the destination server 220 may check the source IP address of the client 208, the destination IP address, port numbers, user id and/or any authentication information. If the connection is granted, a connection is established between the client 208 and the destination server 220 in accordance with the request 502. The destination server 220 at step 620 generates a connection request reply 504 indicating a successful connection request status. The destination server 220 may also generate or provide data blocks 320a-320c as part of the handshake packet 300 of the connection request reply 504. For example, the destination server 220 may provide reconnection tickets for the client 208 and the first proxy 120a as part of security data blocks 320a and 320b. These reconnection tickets may be generated by a ticket authority service of the destination server 220 or otherwise available to the destination server 220 via the network 104′. Furthermore, the destination server 220 may provide in the other data block 320c of the connection request reply 504, any application specific data for the client 208, for example, a file.

In one embodiment, the proxied connection 202-20n is established one connection, or hop, at a time from the destination server 220 to the client 208. The destination server 220 at step 620 transits the connection request reply 504 to the client 208 by way of proxy N 120n. When proxy N 120n, at step 622, receives and processes the connection request reply 504, proxy N 120n may establish the connection 202n between proxy N 120n and destination server 220. Further, at step 622, proxy N 120n forwards the connection request reply 504 to the second proxy 120b. At step 624, the second proxy 120b processes the connection request reply 504 and establishes the connection 202b between the second proxy 120b and proxy N 120n. The second proxy 120b then forwards the connection request reply 504 to the first proxy 120a. At step 626, the first proxy 120b processes the connection request reply 504 and establishes the connection 202a between the first proxy 120a and the second proxy 120b. Further, at step 626, the first proxy 120a may process a security data block 320b comprising a ticket for the first proxy 120a. As such, the first proxy 120a may delete the security data block 320b from the connection request reply 504 before transmitting to the client 208.

At step 630, the client 208 receives from the first proxy 120a the connection reply request 504 in response to sending out the connection request 502. The client 208 at step 635 may establish the final connection 220 of the proxied connection 220-220n to the destination server 220. In other embodiments, each of the connections 202-202n of the proxied connection 202-202n are not established until the client 208 receives the connection reply request 504. One ordinarily skilled in the art will appreciate the various sequences in which the proxied connection 202-202n may be established in response to a connection request 502.

Additionally, at step 630, the client 208 may process the other data block 220c to obtain the file. In one example, the file may comprise an executable to run that establishes the connection 202 to the first proxy 120a at step 634, which may also include transmitting the ticket provided in the security data block of 320a. In summary, steps 610 through 630 of the illustrative method of FIG. 5 complete the single handshake of the connection request handshake 505 depicted in FIG. 5.

In another embodiment, at step 618 and 620, the destination server 220 may reject the connection request 504 and generate a connection request reply 504 with an error status. The destination server 220 then transmits this connection request reply 504 to the client via proxy N 120n. At steps 622, 624 and 624, the respective proxies 120a-120n process the connection request reply 504 and forward it to the next proxy 120a-120n. In the case of a connection rejection, the proxies 120a-120n determine a rejection or error status from the network connection reply 504, for example, from the packet data 310, and do not establish any proxied connection 202-202n. At step 626, the first proxy 120a transmits the connection request reply 504 to the client 208, and at step 630, the client may display an error message to the user or application attempting the connection. In the case of a failed connection attempt, the destination server 220 may not include any data blocks 320a-320n in the connection request reply 504 sent back to the client 208.

Once a proxied connection 202-202n is established between the client 208 and the destination server 220, the client 208 and the destination server 220 can communicate to each other and have the functionality of the connection 202-202n enforced or otherwise applied by the proxies 120a-120n. Each of the proxies 120a-120n are responsible for forwarding network packets between the client 208 and the destination server 220. However, under the present invention, each proxy 120a-120n may focus on its functionality and ignore or skip data blocks 320a-320n of network packets 300, 300′ to which it is not concerned. This can minimize computation or processing time per network packet 300 per proxy 120a-120n as the proxy 120a-120n does not need to parse or understand any further part of the network packet 300. This reduces connection time and network latency. Also, the present invention allows for improved scalability of proxies 120a-120n as each proxy 120a-120n can handle more connections.

Referring still to FIG. 6, the illustrative method depicts the steps involved in practicing the invention after establishing the proxied connection 202-220n. At step 640, the client 208 may initiate a communication to the destination server 220. The communication is sent to the first proxy 120a, which, at step 642, applies its functionality to the network packet. In some cases, the first proxy ignores or skips portion of the network packet. In other cases, the first proxy 120a may not perform any computation and forward the network packet on the connection 202a. In the illustrative embodiment of FIG. 5, the first proxy 120a provided an outer security gateway, and therefore, at step 642 may apply and/or enforce security policy rules configured during the connection establishment of steps 610 through steps 630 described above. Likewise, the second proxy 120b through proxy N 120n of steps 644 and s646 would apply their configured functionality to the network communications destined for the destination server 220. By way of example of FIG. 5, the second proxy 120b would enforce the encryption policy on the network packets 300 and proxy N 120n would enforce the compression rules on the network communications. In a similar manner, the destination server 220 may communicate to the client 208 either in response to a client communication or asynchronously. At steps 662, the destination server 220 communicates to the client 208 and at steps 662 through 666, each of the proxies 120a-120n apply their functionality to the communication en route to the client 208. For their part, each proxy 120a-120n forwards the communication to the next proxy 120a-120n in the chain to the client 208, unless some policy or rule is not met and the communication is rejected.

In another aspect, the systems and methods described above can be useful for traffic classification in Quality of Service (QoS) networking systems, and for providing and servicing end-to-end QoS levels. In general, the term QoS is related to guaranteeing levels of throughput in networking. One of the goals of QoS is to provide traffic priority including dedicated bandwidth and controlled latency with improved loss characteristics. As such, QoS can provide better service to certain network connections by performing congestion management, and increasing the priority of certain connections while lowering the priority of other connections. One ordinary skilled in the art will appreciate the purposes, goals and implementations of QoS in the context of networking such as in the present invention.

For example, in reference to FIG. 5, the system 500 can be used to implement a QoS. One or all of the proxies 120a-120n can inspect handshake packets 300 during an end-to-end handshake, e.g., 350, 505, to implement identification and marking techniques for coordinating QoS from end-to-end between the client 208 and the destination server 220. One, some or all of the proxies 120a-120n can inspect the handshake packets 300 to determine traffic or payload type for QoS management of the proxied connection 202-202n. Additionally, any of the proxies 120a-120n may add, delete or otherwise modify QoS-specific information in the handshake packets 300 to control and manage the end-to-end QoS for the proxied connection 202-202n. As handshake packets 300 traverse through the network connection 202-202n, other network devices, proxies 120a-120n, or the end points of the client 208 and the destination server 220 can interpret the QoS-specific information to participate in the characteristics and functionality of the connection 202-202n in accordance with this invention. Furthermore, any proxy 120a-120n in managing any adjacent connection 120a-120n can perform congestion and queue management, and implement trafficking shaping and policing rules in support of either QoS for the proxy 120a-120n, the server 210 or network device hosting the proxy 120a-120n, or otherwise for end-to-end QoS service. For example, the mechanisms of the system 500 can be used to inform any interested element, e.g., proxy 120a-120n, of the connection 202-202n that the connection 202-202n is traversing a bandwidth-limited network segment, such as a modem link, so that the interested element may participate in optimizing payload characteristics for the connection 202-202n. One ordinarily skilled in the art will recognize and appreciate how the present invention may be used to perform QoS in general, and in particular for either a single network element or for end-to-end QoS In yet a further aspect, the systems and methods of the present invention can also useful for logging information with regards to the connection 202-202n for such purposes as auditing and troubleshooting. As network packets 300 traverse a proxy 120a-120n, a proxy 120a-120n can inspect the handshake packet 300 and log information interpreted from or otherwise read from the packet. Also, each proxy 120a-120n can log any information with respect to any action or result and status of the action taken by the proxy 120a-120n with respect to establishing and controlling the proxied connection 202-202n. In a similar manner, the client 208 and/or destination server 220 may log any information with handshake packets 300 it receives or sends, and any actions and results of actions taken. The information can be logged by any conventional means such as a log file, database, logging services of the operating system, another application, etc.

Furthermore, one or more of the proxies 120a-120n, client 208 and/or destination server 220 can forward logging information via the handshake packets 300 to any other proxy 120a-120n or end point of the proxied connection 202-202n. For example, any information about the environment related to the operation a proxy 120-120n, client 208 and/or destination server 220 can be logged locally and/or forwarded by the way of the data blocks 320a-320n of the handshake packet 300. The environment information may include any information about the elements, type, versions, or any other characteristic of the operating system, network environment, computing device, or any other software or hardware that may affect the proxied connection 202-202n. In another example, a proxy 120a-120n can add an identification tag to the handshake packet 300 to forward to other proxies 120a-120n and end points to provide information on how the connection 202-202n was routed. One ordinarily skilled in the art will recognize the multitude of information that may be logged with regards to the proxied connection 220-220n and forwarded by way of a handshake packet 300.

In another aspect, the client 208, destination server 220, and/or any proxy 120a-120n can act as a logging device, or logging application, for logging any information with regards to the proxied connection 220-220n. For example, the handshake packets 300 may comprise one or more logging data blocks 320a-320n containing data 322a-322n provided for logging. A logging proxy 120a-120n may interpret and read these logging data blocks 320a-320n as the handshake packet 300 traverses its connection. Other proxies 120a-120n or end points may ignore the logging data blocks 320a-320n if they are not concerned with or configured to inspect these types of data blocks 320a-320n. In this manner, the logging proxy 120a-120n may comprise a log that has an aggregate view of the end-to-end connection. In another example, the client 208 and/or the destination server 220 log all the logging data blocks 320a-320n received to provide the end-to-end aggregate view of the connection 220-220n. Additionally, each proxy 120a-120n, client 208 and destination server 220 can act as its own logging application to log information with respect to its adjacent connections 202-202n. One ordinarily skilled in the art will appreciate the various ways that information may be logged in accordance with the present invention.

Although generally discussed from a perspective of an IP-routed Ethernet type of network, the protocol, systems and methods of the present invention can be applied to other communication networks over various technologies, including Frame Rely, Asynchronous Transfer Mode (ATM) and SONET. One ordinarily skilled in the art will appreciate how the present invention may be applied to other types of communications networks and other types of networking technologies.

As described above, the present invention provides a system, method and protocol by which a client's access to a complex network topology can be configured and controlled independently by one or more proxies from client to the access end-point in the network. The proxied connection is established and controlled by a network protocol that enables all proxies to participate in the connection and end-to-end connection management by a single end-to-end handshake. Furthermore, the network protocol is forward compatible enabling for the flexible and easier upgrading of proxies and servers in the connection path without losing the ability to establish and control the connection because of protocol upgrades. With self-describing data blocks, the protocol and system enables new functionality to be easily added to the protocol and proxies for providing more control and functionality to existing connections.

Many alterations and modifications may be made by those having ordinary skill in the art without departing from the spirit and scope of the invention. Therefore, it must be expressly understood that the illustrated embodiments have been shown only for the purposes of example and should not be taken as limiting the invention, which is defined by the following claims. These claims are to be read as including what they set forth literally and also those equivalent elements which are insubstantially different, even though not identical in other respects to what is shown and described in the above illustrations.

We claim:

1. A method for network communications, the method comprising the steps of:
transmitting, by one of a client and a first proxy via a proxy protocol, a handshake request packet to a second proxy, the handshake request packet comprising one or more data blocks;
initiating, by the second proxy, a change to the handshake request packet, the change comprising one of modifying, adding and deleting a data block of the one or more data blocks;
forwarding, by the second proxy via the proxy protocol, the changed handshake request packet to one of a third proxy and a destination server;
receiving, by the second proxy via the proxy protocol, a handshake response packet representing a result from forwarding the handshake request to the destination server; and
replying, by the second proxy via the proxy protocol, to the handshake request packet sent by one of the client and the first proxy with the handshake response packet.

2. The method of claim 1, wherein at least one of the one or more data blocks comprises a field indicating the total length of the block.

3. The method of claim 1, wherein at least one of the one or more data blocks comprises data describing the type of data block.

4. The method of claim 1, wherein at least one of the one or more data blocks represents a capability of one of the first proxy, the second proxy and the third proxy.

5. The method of claim 4, wherein at least one of the one or more data block comprises information describing one or more of the following capabilities: compression, security and encryption.

6. The method of claim 1, wherein at least one of the one or more data blocks represents a policy to be applied to the connection between the client and the destination server.

7. The method of claim 6, wherein the policy comprises rules associated with one or more of the following: compression, security, and encryption.

8. The method of claim 1, further comprising the step of recognizing, by the second proxy, the type of at least one of the one or more data blocks.

9. The method of claim 1, further comprising the step of ignoring, by the second proxy, one of the one or more data blocks.

10. The method of claim 1, further comprising initiating, by the second proxy, a change to the handshake response packet.

11. The method of claim 1, wherein the handshake request packet comprises a request from the client to connect to the destination server.

12. The method of claim 1, wherein the handshake response packet comprises a reply from the destination server to a request from the client to connect to the destination server.

13. The method of claim 1, wherein the proxy protocol comprises the Common Gateway Protocol.

14. The method of claim 1, wherein the proxy protocol comprises the SOCKS protocol.

15. The method of claim 1, wherein the proxy protocol is forward-compatible.

16. A method for establishing a connection between a client and a destination server via a handshake across multiple proxies, the method comprising the steps of:
sending, by a client via a proxy protocol to a first proxy, a connection request to connect to a destination server, the connection request comprising at least one data block;
forwarding, by the first proxy via the proxy protocol, the connection request to a second proxy;
forwarding, by the second proxy via the proxy protocol, the connection request to the destination server;
receiving, by the second proxy via the proxy protocol, a reply to the connection request from the destination server, the reply comprising at least one data block;
forwarding, by the second proxy via the proxy protocol, the reply to the first proxy; and
replying, by the first proxy via the proxy protocol, to the connection request of the client with the reply from the destination server.

17. The method of claim 16, further comprising the step of taking, by one of the first proxy and the second proxy, an action to perform one of the following changes to the connection request: adding a data block, modifying the least one data block, and removing the least one data block.

18. The method of claim 16, further comprising the step of taking, by one of the first proxy and the second proxy, an action to perform one of the following changes to the reply:
adding a data block, modifying the least one data block, and removing the least one data block.

19. The method of claim 16, further comprising the step of establishing a connection between the client and the destination server.

20. The method of claim 19, further comprising the step of forwarding, by the first proxy and the second proxy, communications from the client to the destination server via the connection.

21. The method of claim 19, wherein the connection request comprises at least one data block representing an operational characteristic of the connection to be connected between the client and the destination server.

22. The method of claim 19 wherein the connection request comprises at least one data block representing a policy to be enforced for the connection between the client and the destination server.

23. The method of claim 22, wherein the policy comprises one or more rules associated with one of compression, security and encryption.

24. The method of claim 22, further comprising the step of enforcing, by one of the first proxy and the second proxy, the policy represented by the least one data block.

25. The method of claim 17, wherein the least one data block of one of the connection request and the reply represents a capability to be configured within a proxy.

26. The method of claim 25, wherein one of the first proxy and the second proxy reads the least one data block and takes an action to apply the capability in handling the connection between the client and the destination server.

27. The method of claim 16, wherein the first proxy comprises a version of the proxy protocol different than the version of the proxy protocol of one of the second proxy and the destination server.

28. The method of claim 27, wherein one of the second proxy and the destination server ignore at least one of the data blocks in communications from the first proxy comprising the different version of the proxy protocol.

29. The method of claim 27, wherein at least one of the data blocks of one of the connection request and reply comprises a ticket.

30. A system for establishing a connection between a client and a destination server through a plurality of proxies, the system comprising:
a client communicating, via a proxy protocol, a connection request to establish a connection with a destination server, the connection request comprising one or more data blocks;
a first proxy, in communication with the client via the proxy protocol, receiving the connection request and forwarding the connection request;
a second proxy, in communication with the first proxy via the proxy protocol, receiving the connection request forwarded by the first proxy, the second proxy forwarding the connection request to the destination server; the destination server, in communication with the second proxy via the proxy protocol, replying to the connection request by communicating a reply to the second proxy, the reply comprising one or more data blocks;
the second proxy receiving the reply and forwarding the reply to the first proxy;
the first proxy receiving the reply and communicating the reply to the client in response to the connection request by the client.

31. The system of claim 30, wherein one of the first proxy and the second proxy perform a change to the one or more data blocks of the connection request, the change comprising one of the following: adding a data block, modifying one of the one or more data blocks, removing one of the one or more data blocks.

32. The system of claim 30, wherein one of the first proxy and the second proxy perform a change to the one or more data blocks of the reply, the change comprising one of the following: adding a data block, modifying one of the one or more data blocks, removing one of the one or more data blocks.

33. The system of claim 30, wherein the first proxy and the second proxy establish a connection between the client and the destination server.

34. The system of claim 33, wherein the first proxy and the second proxy forward communications from the client to the destination server via the connection.

35. The system of claim 30, wherein the connection request comprises at least one data block representing an operational characteristic of the connection between the client and the destination server.

36. The system of claim 30, wherein the connection request comprises at least one data block representing a policy to be enforced for the connection between the client and the destination server.

37. The system of claim 36, wherein the policy comprises one or more rules associated with one of compression, security and encryption.

38. The system of claim 37, wherein one of the first proxy and the second proxy enforces the policy on the connection.

39. The system of claim 30, wherein the least one data block of one of the connection request and the reply represents a capability to be configured by a proxy.

40. The system of claim 39, wherein one of the first proxy and the second proxy reads one of the one or more data blocks and takes an action to apply the capability in handling the connection between the client and the destination server.

41. The system of claim 30, wherein the first proxy uses a version of the proxy protocol different than the version of the proxy protocol used by of one of the second proxy and the destination server.

42. The system of claim 41, wherein one of the second proxy and the destination server ignore one of the one or more data blocks in communications from the first proxy comprising the different version of the proxy protocol.

43. The system of claim 30, wherein one of the one or more data blocks of one of the connection request and the reply comprises a ticket.
